(19) United States
(12) Patent Application Publication
(10) Pub. No.: US 2009/0208286 A1
(43) Pub. Date: Aug. 20, 2009

(54) Synthetic Kerbs and Method of Installation

(75) Inventor: Philip Sutton, Birmingham (GB)

Correspondence Address: Richard A. Rezek;Barnes & Thornburg, 11 South Meridian Street, Indianapolis, IN, 46204, US

(73) Assignee: Durakerb Limited, Merseyside (GB)

(21) Appl. No.: 10/593,126

(22) PCT Filed: Mar. 21, 2005
(86) PCT No.: PCT/GB05/01070

§ 371 Date: Jun. 9, 2008

(30) Foreign Application Priority Data
Mar. 20, 2004 (GB) 0406307.9

(51) Int. Cl. E01C 11/22; F21V 9/00; H05B 37/02; B60Q 1/48

(52) U.S. Cl. 404/7; 362/231; 315/294; 340/932.2

(57) ABSTRACT

A plastics or rubber kerbstone (10) has a body which defines a flange for assisting retention of the kerbstone, in use. A kerb race reinforcement structure (80) is also disclosed. The kerb race reinforcement structure has a preformed body which defines a base and a kerb carrying surface displaced from the base so as to define a cavity between the base and the carrying surface.

This invention relates to kerbstones and a method of laying kerbstones to form a kerb. In particular, but not exclusively, the invention relates to synthetic kerbstones and a method of laying kerbstones to form a kerb where the kerbstones are secured in a single concrete application procedure.

During the early stages of a construction project, such as, for example, a housing development, consideration must be given as to how construction vehicles will access the construction site. It is common to provide access roads relatively early on in the construction project. Typically, a base course tarmac will be laid onto a sub-base, the base course acting as a road surface to allow construction vehicles access to the project site. Usually, kerbstones will also be laid at this stage since the kerbstone is often partially retained by the base course tarmac.

At present the process of laying kerbstones is costly and slow. The process begins by laying a concrete race onto the sub-base and inserting pins into the concrete, leaving one end of the pins exposed. Once the concrete has cured these pins are usually bent flat until required so as not to cause a hazard during construction. After the pins have been bent back into position the kerbstones are laid onto the sub-base against the pins. A second concrete application then secures the kerbstone in place by applying a haunch to either side of the kerbstone. The haunch provides some resistance to the load encountered by the kerbstone once the base course tarmac and surface tarmac has been applied to the sub-base.

However, this process has a number of problems. Firstly, the process is slow since each concrete application (the forming of the race, and the forming of the haunching) must be allowed to dry before proceeding with the next stage of the process. Secondly, existing concrete kerbstones each weigh in excess of 25 kg. Manual handling of the kerbstone presents therefore a substantial health and safety hazard. The alternative is to move the kerbstones mechanically, but this clearly adds further cost and delay to the process. Furthermore, since the surface tarmac is not laid until the end of the construction project, the kerbstones lie partially exposed during the construction phase and are thus susceptible to damage from construction vehicles. As a result many kerbstones must be dug out and replaced towards the end of the construction project shortly before the surface tarmac is applied. This further adds to the cost of the process and exacerbates the manual handling hazard.

An additional problem with the known method of constructing a kerb is that the concrete race is prone to failure due to the loads exerted upon it by the base course and surface tarmac layers and the vehicles that are carried on the tarmac. Since the kerbstone is supported directly by the race, failure of the race frequently results in the collapsing of the kerbstone. At present this is the most frequent cause of kerbstone replacement.

A further problem with conventional kerb construction is that the kerbstone race is often constructed from poorer quality aggregate and as a result has an increased liability to failure. In addition to the problems of failure, at present the race is constructed separately from the rest of the kerb. This adds unnecessary delay and cost to the process of forming the kerb.

A number of solutions have been proposed to overcome these problems. GB2369642 discloses a synthetic kerbstone which is located in a base. The base is retained permanently within the road structure and the kerbstone is removable so that a synthetic kerb used during the construction phase can be replaced by a traditional concrete kerb for permanent use thereafter. This teaching does not tackle the unnecessary complexity of the kerb construction, indeed the process of construction is further complicated by the requirement to replace the kerb. Furthermore, the manual handling hazard remains since conventional 25 kg kerbstones must be introduced into the base before completion of the road surface.

GB2298882 goes someway to addressing the manual handling hazard by disclosing a synthetic kerbstone having an overall weight of not more than 25 kg. However, the process of installing this kerbstone is complex, and costly as a result. Furthermore, the kerbstone does not provide sufficient means for retaining the kerbstone in use. This is particularly important since the reduced weight of the kerbstone inherently reduces its stability when struck by a vehicle wheel, or similar.

It is an object of the present invention to provide an improved kerbstone, kerbstone race, and method of construction of a kerb.

According to the present invention there is provided a kerbstone having a body which defines a retention formation for assisting retention of the kerbstone, in use.

Advantageously, the retention formation increases the overall strength of any kerb in which the kerbstone is used since the formation reduces the likelihood of a kerbstone being dislodged under impact from, for example, a vehicle wheel. This feature affords the kerbstone greater resistance to damage in that it is more securely retained on the race. this in turn reduces the risk that the kerbstone will need to be replaced, either before the end of the construction phase, or during its working life. The retention formation also allows the overall weight of the kerbstone to be reduced since the weight of the kerbstone is no longer critical in maintaining its position on the race. As a result the kerbstone may be formed from a lightweight material, since the retention formation securely retains the kerbstone in its installed position, negating the requirement for the kerbstone to carry additional weight in order to achieve a similar level of stability.

Preferably, the body is defined by a leading surface, a front face, a rear face, a base and first and second end faces, the leading surface comprising a top face and a forward face.

More preferably, the retention formation includes first and second retention elements on the first and second end faces, respectively.

According to a second aspect of the invention there is provided a kerbstone assembly comprising at least two kerbstones in accordance with the first aspect of the invention wherein the first retention element of a first kerbstone is suitable for engagement with the second retention element of a second kerbstone.

Advantageously, the retention elements afford the kerbstone assembly increased rigidity over an assembly of prior art kerbstones. This increased rigidity holds the kerbstone in place before application of the haunching concrete. It also reduces the chance of a kerbstone needing to be replaced following failure of the underlying race.

According to a third aspect of the invention there is provided a kerb race reinforcement structure having a preformed body which defines a base for supporting a kerb carrying surface for carrying a kerbstone, the kerb carrying surface being displaced from the base so as to define a cavity between the kerb carrying surface and the surface onto which the structure is to be laid, in use.

An advantage of this structure is that it provides increased strength to the kerb race thereby reducing the chance of the failure of the kerb. It also provides a level base on which to install the kerbstones prior to application of the haunching concrete.

According to a fourth aspect of the invention there is provided a kerbstone and kerb race reinforcement structure subassembly including a kerbstone and at least one race reinforcement structure according to the third aspect of the invention.

This assembly allows the line that the kerb is to follow to be laid out accurately since the kerb race reinforcement structure will hold the kerbstone in place securely before and during the application of a concrete mix to form the brace. This reduces the time spent realigning the kerbstones after application of the haunching concrete.

According to a fifth aspect of the invention there is provided a method of forming a kerb comprising the steps of laying the kerb race reinforcement structure of the third aspect of the invention onto a sub-base, installing at least one kerbstone on the kerb race reinforcement structure such that the or each kerbstone is retained on the kerb race reinforcement structure, pouring a concrete mix onto the sub-base so as to fill the race cavity with concrete mix to form a kerb race and to fix the or each kerbstone on the kerb race.

Advantageously, this method provides a fast and efficient method of constructing a kerb race. Furthermore, a strong and reliable race is formed for receiving the or each kerbstone. This greatly reduces the chance of the kerb failing either during the construction process or during its working life.

According to a sixth aspect of the invention there is provided a method of forming a kerb race comprising the steps of laying a race formed from a semi-dry concrete mix, inserting into the semi-dry concrete mix at least one spigot receiving structure and allowing the concrete to dry.

Advantageously, this method provides a level race which does not prove a hindrance to construction vehicles and personnel. Unlike prior art races there are no protrusions from the race surface to present a health and safety risk. The kerb race does not include pins which must be bent down after formation of the race and subsequently bent back up when the kerbstones are to be laid on the race. Rather, spigots are inserted into the spigot receiving structure at a later date when the kerbstones is to be laid onto the race.

The invention will now be described, by way of example only, with reference to the accompanying drawings in which:

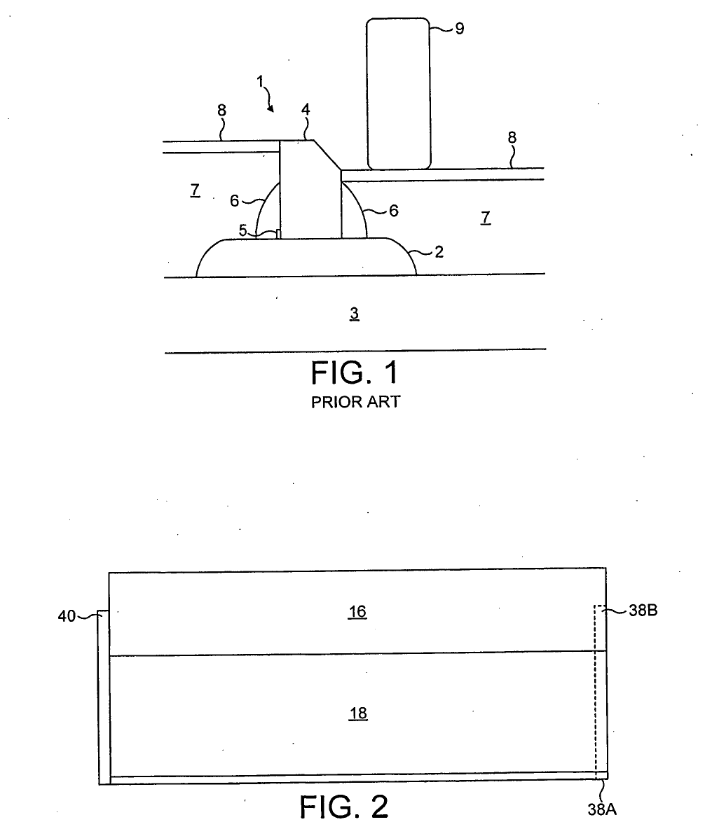

FIG. 1 is a schematic end view of a prior art kerb construction,

FIG. 2 is a front view of a kerbstone in accordance with the first aspect of the present invention,

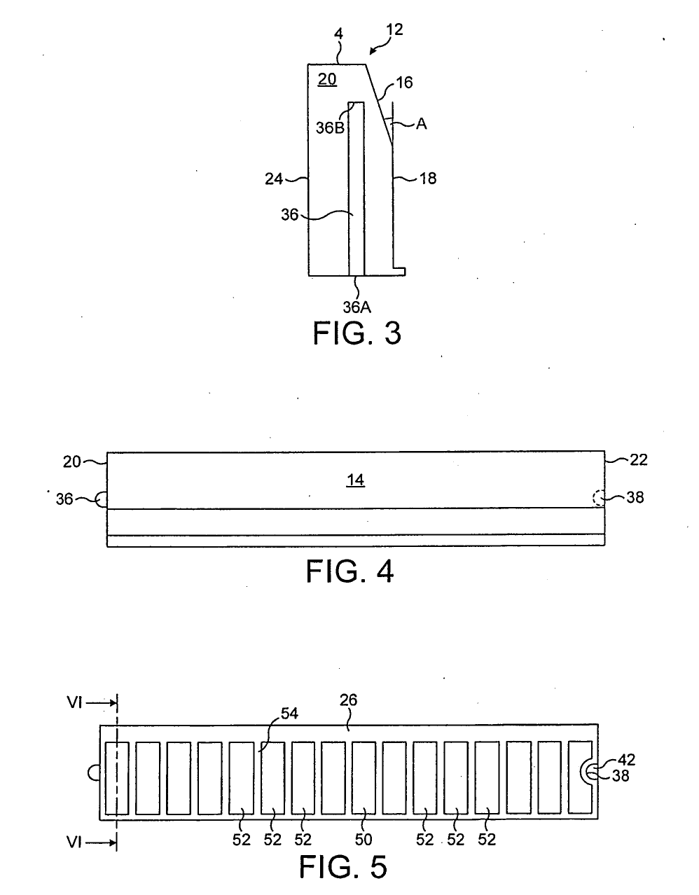

FIG. 3 is an end view of the kerbstone of FIG. 2,

FIG. 4 is a top view of the kerbstone of FIG. 2,

FIG. 5 is a bottom view of the kerbstone of FIG. 2,

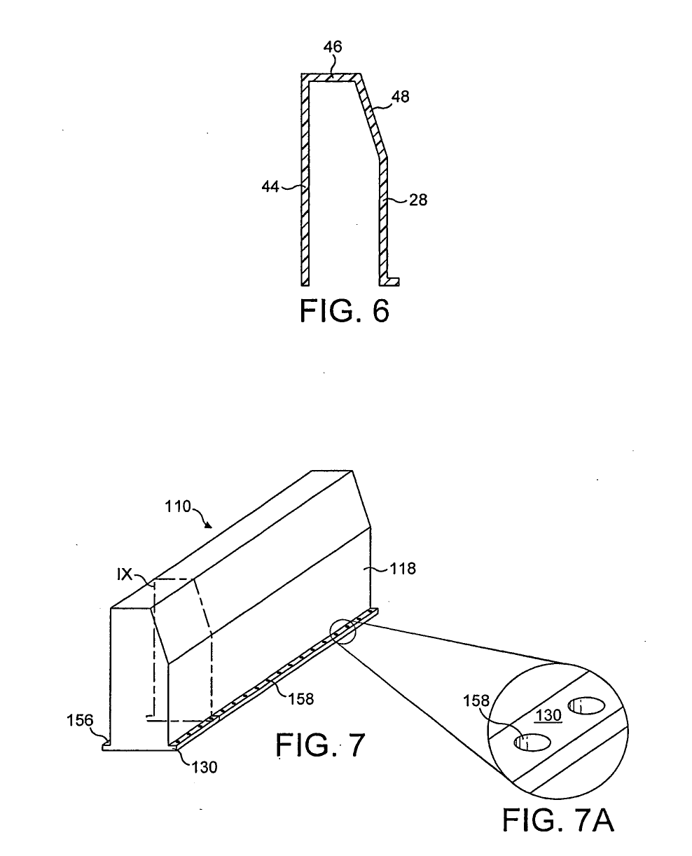

FIG. 6 is an end view cross-section of the kerbstone of FIG. 5 taken along line VI-VI in FIG. 5,

FIG. 7 is an isometric view of a second embodiment of the kerbstone of the present invention,

FIG. 7A is an exploded view of part of the kerbstone of FIG. 6 showing the front flange in further detail,

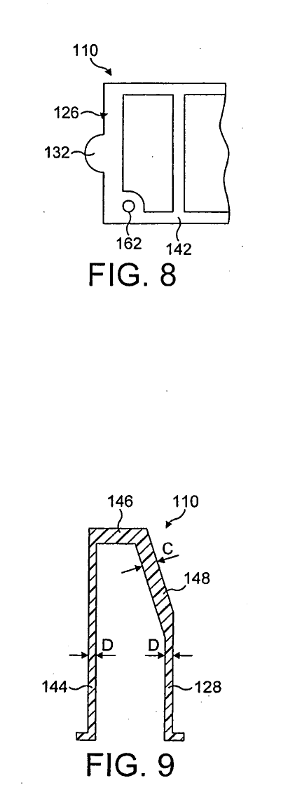

FIG. 8 is a partial bottom view of a base the kerbstone of FIG. 7,

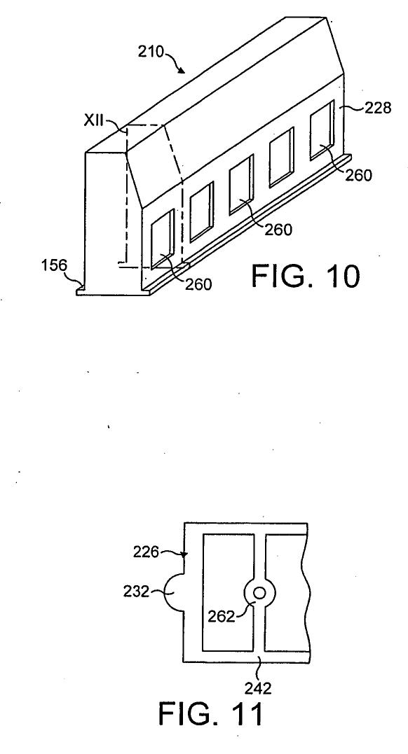

FIG. 9 is an end view cross-section of the kerbstone of FIG. 7 taken in plane IX-IX in FIG. 7 showing an alternative embodiment to the kerbstone of FIG. 5A,

FIG. 10 is an isometric view of a third embodiment of the kerbstone of the present invention,

FIG. 11 is a partial bottom view of a base of the kerbstone of FIG. 10,

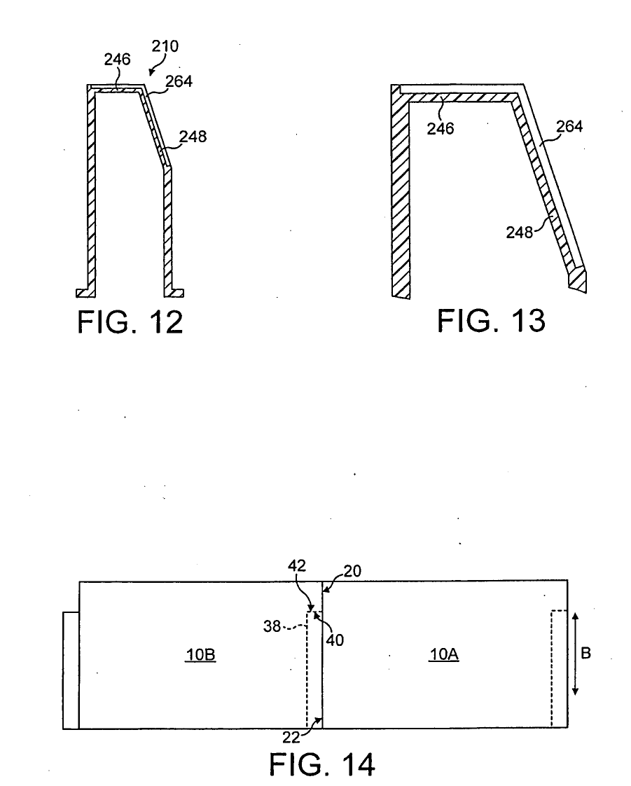

FIG. 12 is an end view cross-section of the kerbstone of FIG. 10 taken in plane XII-XII in FIG. 10,

FIG. 13 is an enlarged view of part of the end view cross-section of FIG. 12,

FIG. 14 is a schematic front view of a kerbstone assembly in accordance with the present invention,

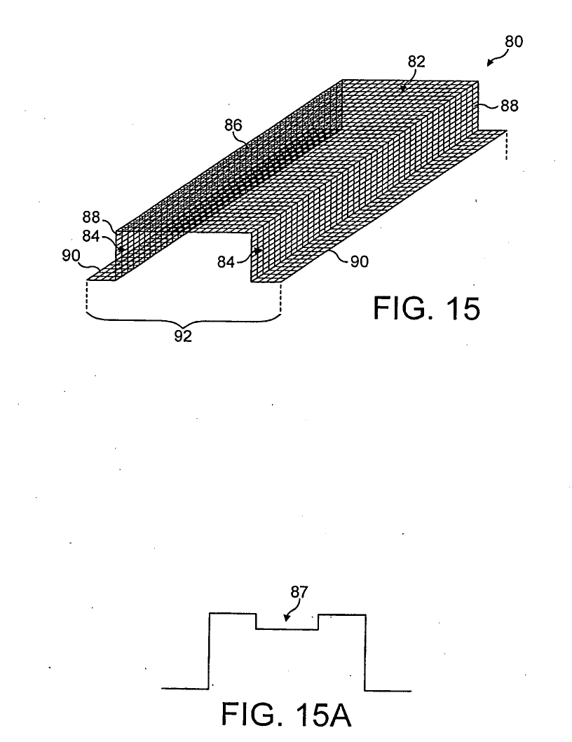

FIG. 15 is an isometric view of a kerb race reinforcement structure in accordance with the present invention,

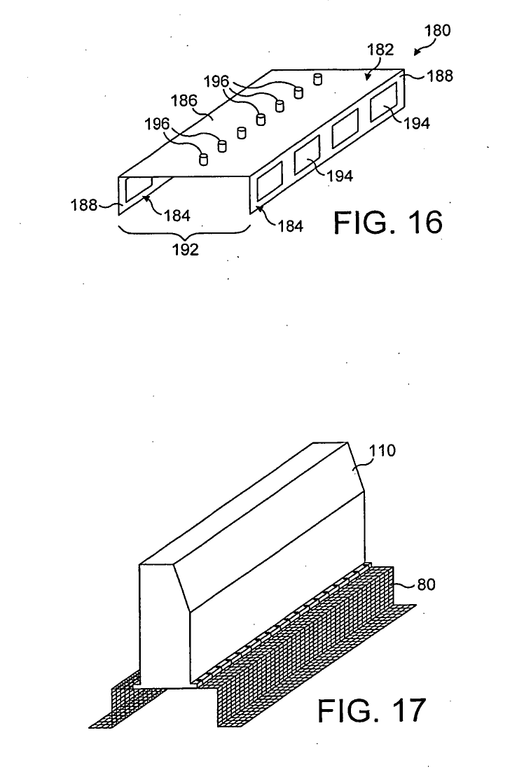

FIG. 16 is an isometric view of a second embodiment of the kerb race reinforcement structure according to a second embodiment of the present invention,

FIG. 17 is an isometric view of a kerbstone and kerb race reinforcement structure sub-assembly according to the present invention,

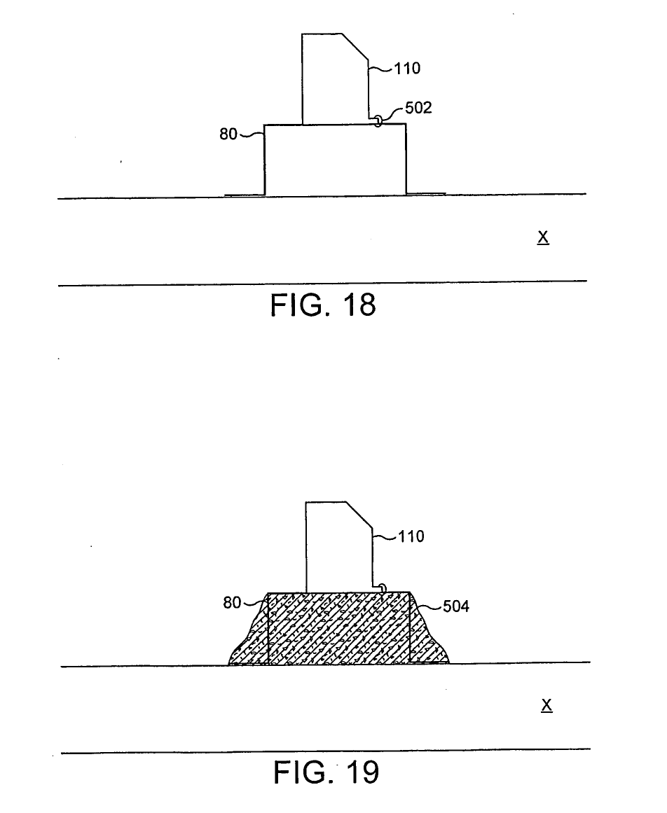

FIG. 18 is a schematic end view of a part formed kerb which depicts a first stage in a method of forming a kerb in accordance with the present invention,

FIG. 19 is a schematic end view of the part formed kerb of FIG. 18 showing a second stage in the method of forming a kerb in accordance with the present invention,

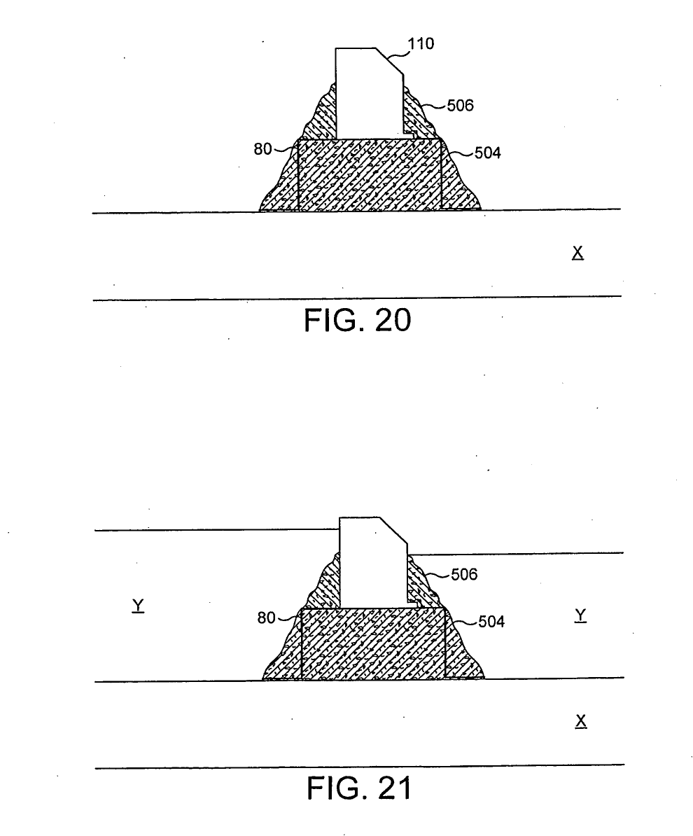

FIG. 20 shows a schematic end view of the part formed kerb of FIG. 19 showing a third stage in the method of forming a kerb in accordance with the present invention,

FIG. 21 is a schematic end view of the part formed kerb of FIG. 20 showing a fourth stage in the method of forming a kerb in accordance with the present invention,

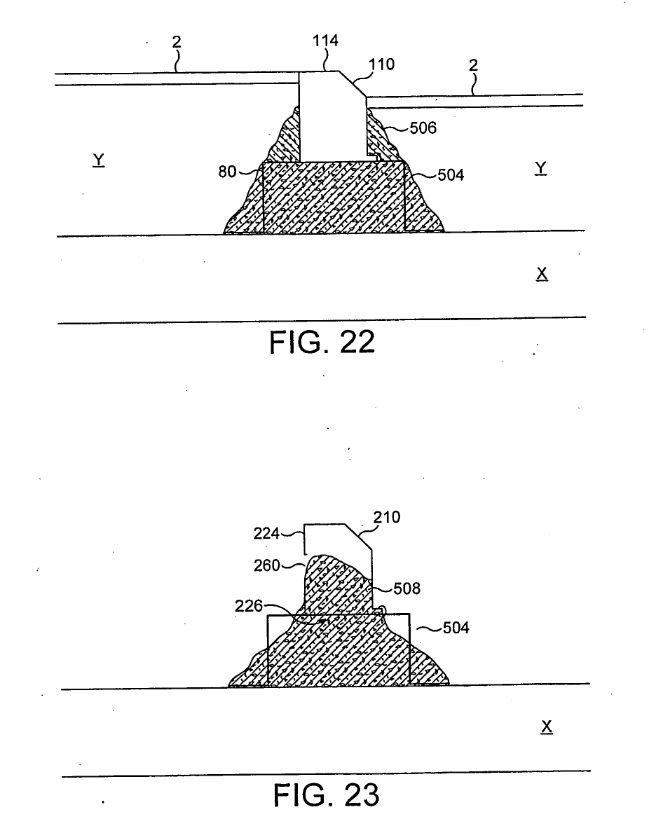

FIG. 22 is a schematic end view of the part formed kerb of FIG. 21 showing a fifth stage in the method of forming a kerb in accordance with the present invention,

FIG. 23 is a schematic end view of a second embodiment of a part-formed kerb in accordance with the present invention showing a second step in an alternative method of forming a kerb in accordance with the present invention,

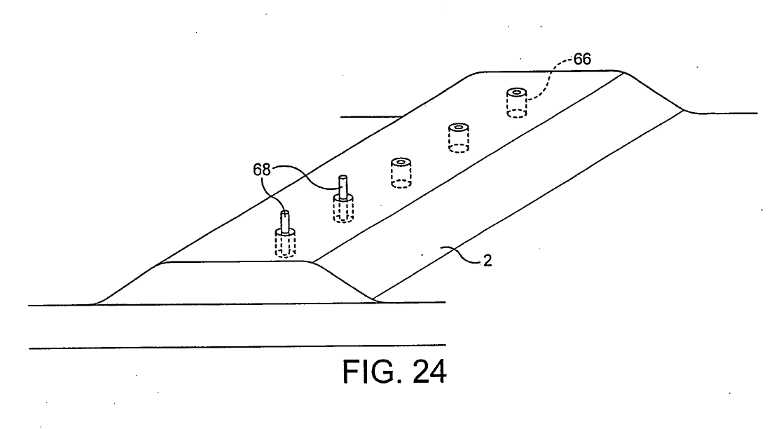

FIG. 24 is an isometric view of a kerbstone race in accordance with the present invention,

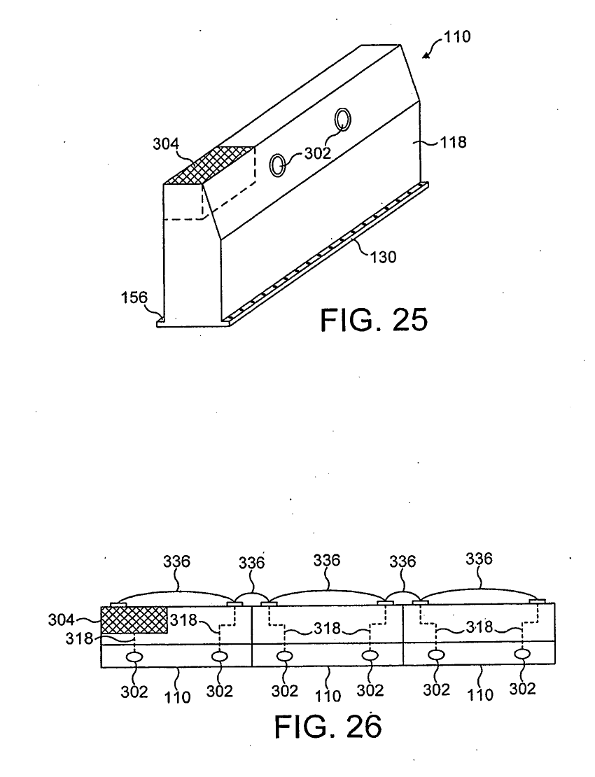

FIG. 25 is an isometric view of another kerbstone in accordance with the invention,

FIG. 26 is a plan view of an assembly of three FIG. 25 kerbstones,

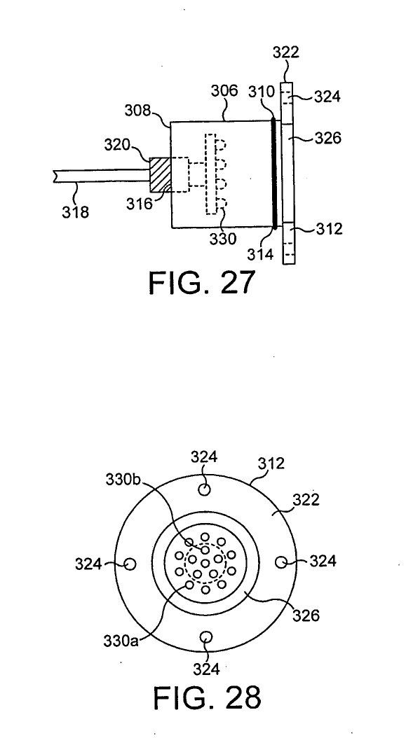

FIG. 27 is a side elevation of a lighting unit from the kerbstone of FIG. 25,

FIG. 28 is an end elevation of the lighting unit of FIG. 27, looking in the direction of arrow XXVIII in FIG. 27,

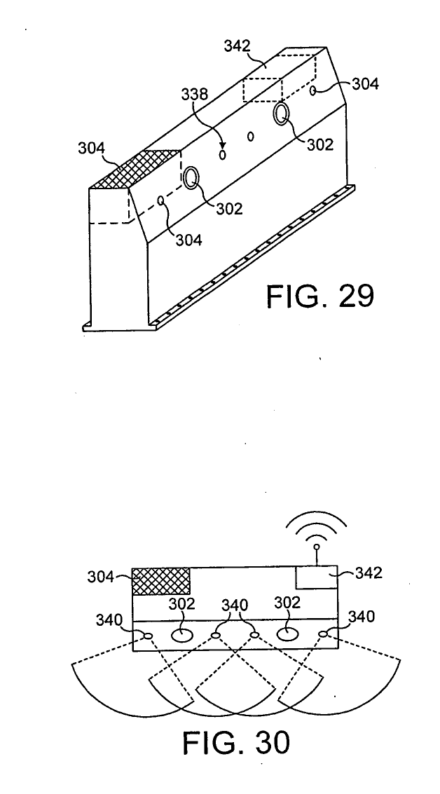

FIG. 29 is an isometric view of a kerbstone in accordance with the invention,

FIG. 30 is a plan view of the kerbstone of FIG. 29,

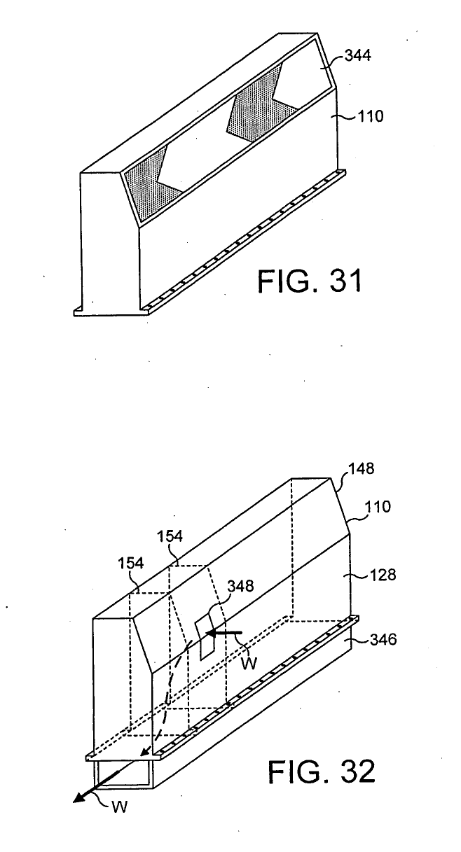

FIG. 31 is an isometric view of a kerbstone in accordance with the invention,

FIG. 32 is an isometric view of a kerbstone in accordance with the invention,

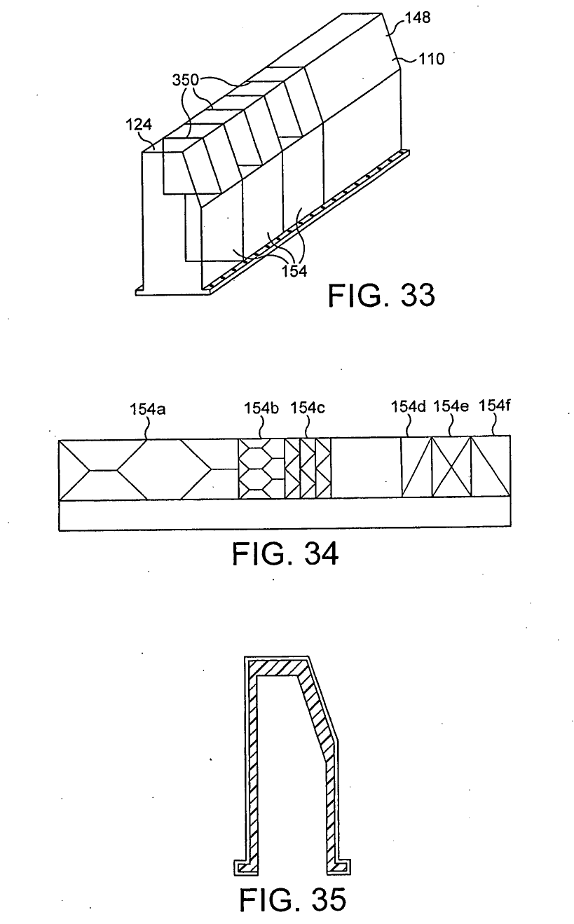

FIG. 33 is an isometric view of a kerbstone in accordance with the invention,

FIG. 34 is a schematic plan view of a kerbstone showing various internal rib configurations, and

FIG. 35 is a sectional view of a kerbstone in accordance with the invention.

Referring to FIG. 1, a typical known kerb will consist of kerb race 2 formed from a concrete mix which is laid onto a sub-base 3. A kerbstone 4 is laid up against a pin 5 which is set into the race 2. The kerbstone 4 is held in position on the race 2 by a pair of concrete haunches 6. A base course tarmac layer 7 is applied onto the sub-base 3 which encloses the race 2 and haunches 6. Onto this base course tarmac 7 is laid the surface tarmac 8.

It will be appreciated that this known process of laying and haunching a kerbstone (not including applying the tarmac layers) is a four-step process. Firstly, the concrete race is formed on the sub-base. Secondly, the pins 5 are inserted into the race 2 and the race is then allowed to dry. Thirdly, the kerbstones are laid up against the pins 5 whilst the race is at least semi-dry. Lastly, the haunching 6 is applied to the race 2 and the kerbstone 4.

The purpose of haunching is to provide lateral support to the kerbstone. This lateral support is required since the action of vehicles over the tarmac surface 8 causes a lateral load to be applied to the kerbstone 4. This lateral load is at a maximum when a vehicle wheel 9 (the vehicle is not shown for clarity) strikes the kerb 4. It will be appreciated that the load associated with such an wheel strike is particularly damaging when construction of the base course tarmac and surface tarmac is not yet complete, as is often the case on a construction site during the construction phase. This problem is exacerbated by the likelihood that construction vehicles are of a substantial weight.

With reference now to FIGS. 2-6, a kerbstone 10 is shown having a leading surface 12 comprising a top face 14 and a forward face 16. The kerbstone 10 further has a front face 18, first and second end faces 20 and 22, a rear face 24 and a base 26 (FIG. 5). With reference in particular to FIG. 6, the forward face 16 is at an angle A to the front face 18 where angle A is approximately 15° degrees. The front face 18 is defined by a front wall 28 which includes a flange 30 which runs the width of the kerbstone 10 at a position approximate the base 26.

The first and second end faces 20, 22 are defined by respective first and second end walls 32, 34. The first end wall 32 includes an end rib 36 which has a semicircular exterior profile (as shown in FIG. 4) and which runs from a position approximate the base 26 at its lower end 36A to a position short of the top face 14 at its upper end 36B. The second end wall 34 includes a recessed channel 38, which has a semicircular interior profile (see FIG. 5). The recessed channel 38 has the same length (from its lower end 38A to its upper end 38B) as the end rib 36 and extends from the base 26 to a position short of the top face 14. The end rib 36 defines an external abutment surface 40 at its upper end 36B and the recessed channel 38 defines an internal abutment surface 42 at its upper end 38B.

The rear face 24 is defined by a rear wall 44 which is substantially flat in profile. Likewise, the top face 14 and forward face 16 are defined respectively by a top wall 46 and a forward wall 48 which are both substantially flat in profile. The intersection between the top wall and forward wall, and forward wall and front wall, is chamfered but might also form a point or be bevelled in alternative embodiments.

The rear wall 44, top wall 46, forward wall 48 and first and second end walls 32, 34 delineate a cavity 50 which is divided into a number of compartments 52 by a series of inner ribs 54. It is conceivable that any appropriate number of inner ribs be employed, FIG. 5 merely indicating a given number by way of example.

The kerbstone 10 is formed from a synthetic plastics material, for example, a low density polyethylene. However, it may also be formed from high density polyethylene, polyurethane, or any other suitable first or second generation plastics material or a composite plastics matrix material. Equally, the kerbstone could be formed from natural or synthetic rubber, or a natural or synthetic rubber composite.

With reference to FIGS. 7, 7A and 8, in which components common with FIGS. 2 to 6 are labelled 100 greater, a kerbstone 110 is shown having a front flange 130 arranged on its front face 118, and a rear flange 156 on its rear face 124. The rear flange 156 runs the width of the kerbstone 110 similar to the front flange 130. Front flange 130 and rear flange 156 define a number of flange holes 158 (shown to a larger scale in FIG. 7A).

In FIG. 8, the base 126 has a first end wall 132 and a rear wall 124 which define an integral retention plug 162 at their interface. It is clearly conceivable that each of the intersections of the end walls 132, 134 and front wall 128 or rear wall 144 could define a plug. The purpose of such a plug is to retain the kerbstone in position during construction of a kerb. The method by which this is achieved is discussed later in the description.

In FIG. 9 the kerbstone 110 has a top wall 146 and a forward wall 148 which has a thickness C which is greater than the thickness D of the front wall 128 and the rear wall 144.

In FIG. 10 a kerbstone 210 is shown, which is similar to those shown in FIGS. 2 to 9. Components common with the kerbstones of FIGS. 2 to 9 are numbered 200 or 100 greater respectively. The kerbstone 210 has a front wall 228 which defines a series of apertures 260. Likewise, the rear wall 244 also defines a series of apertures 260 which are not shown for clarity. The apertures are for receiving a concrete mix during the formation of a kerb, as will be discussed in greater detail shortly. Each compartment has an associated cavity, although it is conceivable within the scope of the invention that only every second, third, or further ratio of cavity has an associated aperture.

Although not shown for clarity, the kerbstone 210 may include any of plural inner ribs 254, end rib and channel 236,238, flange holes 258 and/or variable wall thickness.

FIG. 11 shows an alternative plug arrangement to that shown in FIG. 8, the plug 262 being defined by one of the ribs 236. It is conceivable within the scope of the invention that more than one of the ribs 254 define a plug 262, for example, the plug could be defined at the intersection of the ribs 254 and the front wall 228 or rear wall 244.

In FIG. 12 the kerbstone 210 has a top wall 246 and forward wall 248 which carry an insert 264 which is shown in greater detail in FIG. 13. Since the top wall 146 and forward wall 148 are to be exposed during use, they must be formed from a durable material. Since the other walls are to be buried in use they need only be formed from material which has suitable strength properties, and which need not necessarily be so durable.

In FIG. 14 the kerbstone assembly 70 comprises two kerbstones 10, labelled 10A and 10B. The first end face 20 of the first kerbstone 10A is in abutment with the second end face 22 of the second kerbstone 10B. The rib 36 of the first kerbstone 10A is arranged within the recess channel 38 of the second kerbstone 10B. The external abutment surface 40 of the first kerbstone 10A is in abutment with the internal abutment surface 42 of the second kerbstone 10B. It is conceivable that any number of kerbstones may be fitted together in such a manner so as to form a kerbstone assembly. The purpose of the abutment surfaces 40, 42 is to provide rigidity to the kerbstone assembly 70 in the vertical plane annotated B in FIG. 14.

An existing problem with traditional kerbs is that a failure in the race will almost certainly result in the partial or complete collapse of any kerbstones located above that failure. In contrast, were the race to fail under a kerbstone held in the kerbstone assembly 70 of the current invention, the kerbstone would be supported by its neighbouring kerbstones by means the abutment surfaces 40, 42. By way of example. kerbstone 10B is supported by kerbstone 10A and this method of support would be repeated along the length of the kerbstone assembly. This substantially reduces the chances of any given kerbstone collapsing following an underlying failure in the race.

In FIG. 15 a kerb race reinforcement structure 80 has an upper portion 82 and two side portions 84. The upper portion 82 defines a carrying surface 86 and the side portions 84 each define a leg 88 and a foot 90. The feet 90 form a structure base 92. The race reinforcement structure 80 is formed from a steel mesh, although it is conceivable that the mesh be constructed from another form of material, for example a synthetic plastics material or a metal other than steel. The gauge of the mesh is such that a 20 mm aggregate will pass through the mesh substantially unimpeded. It is conceivable, however, that the mesh could be of an alternative size were a different size of aggregate required.

In FIG. 15A an alternative kerb reinforcement structure cross-section is shown having a kerbstone location channel 87. It is conceivable within the scope of the invention that the kerb reinforcement structure could have a curved rather than a straight profile so as to form a curved kerb.

In FIG. 16, in which features common with the kerb race reinforcement structure of FIG. 15 are number 100 greater, a race reinforcement structure 180 has an upper portion 182 and two side portions 184. The race reinforcement structure 180 is formed from sheet material, preferably a sheet metal such as steel. The side portions 184 define legs 188, the lower end of which form a structure base 192. The legs 188 define a series of leg apertures 194. The leg apertures are for receiving concrete during construction of a kerb, as will be discussed in further detail hereinafter. The upper portion 182 defines a carrying surface 186 which has located on it a series of locator pins 196 which are formed from metal dowel. The pins are for locating in the plugs 162, 262 of the kerbstone of FIGS. 9 and 10, although they may be used in conjunction with any form of kerbstone.

In FIG. 17 a kerbstone and kerb reinforcement structure sub-assembly 500 is shown having a kerbstone 110 mounted on a kerb race reinforcement structure 80. The kerbstone 110 is retained on the structure 80 by a series of zip ties 502 which are threaded through the wire mesh of the structure 80 and flange holes 158 of the kerbstone 110. It is conceivable within the scope of the invention that alternative securing means may be employed such as cable ties or cord.

The securing of the kerbstone 110 to the kerb race reinforcement structure 80 by means of a series of zip ties 502, as shown in FIG. 17, forms the first stage of a method of forming a kerb depicted in FIGS. 18 to 22.

In FIG. 18 a kerb race support structure 80 is laid on to a sub-base X. It is conceivable that the sub-base defines a trench into which the kerb race reinforcement structure is placed. A kerbstone 110 is placed on the kerb race support structure 80 and secured thereto by means of zip ties 502 through the structure mesh and flange holes 158. It may be further secured with the pin and plug assembly described hereinbefore with reference to FIG. 8. In practice the kerb reinforcement structure may be levelled on the race by using wedges, bricks, or any other object capable of supporting the kerb reinforcement structure and kerbstone before application of the concrete.

In FIG. 19 a first concrete mix 504 is applied to the kerb race support structure 80. This first concrete mix may include a preparatory concrete mix which is applied before completion of the first concrete mix and which does not cover the complete kerb race support structure. The preparatory concrete mix will always cover the base of the structure but the carrying surface may be left exposed. The first mix is followed by a second concrete mix 506 so as to partially surround the kerbstone 110 as shown in FIG. 20. In FIG. 21 a base course tarmac Y is laid onto the sub-base X so as to immerse the kerb race support structure 80 and first and second concrete mixes 504, 506.

The last stage of the method is shown in FIG. 22 where a tarmac surface Z has been applied to the base course tarmac Y so that the top face 114 of the kerbstone 110 is flush with an upper portion of the surface tarmac Z.

In FIG. 23 an alternative to the steps shown in FIGS. 20 and 21 is shown where a kerbstone 210 has a one pour concrete mix 508 applied through the apertures 260 in its rear wall 244. The one pour concrete mix 508 flows through the base 226 of the kerbstone 210 so as to fill substantially the kerb race support structure 80 with concrete. It is also conceivable that the concrete be applied to the kerbstone and race reinforcement structure through the front wall of the kerbstone.

In FIG. 24 a conventional race 2 is shown having a number of cylindrical inserts 66 which form spigot receiving structures. These inserts 66 are introduced to the concrete whilst it is a semi-dry state. The race can then be left until such time as the kerbstones are to be laid onto the race. This method of forming a race does not present a health and safety hazard since the surface of the race is substantially flat. This is in contrast to the prior art races which have pins protruding from their surface which much be bent down. Referring again to FIG. 24 spigots 68 are inserted into the cylindrical inserts 66. The exposed end of the spigot is then received by the plug 162, 262 of the kerbstone 110, 210. It is also conceivable within the scope of the invention that the spigots be received by alternative, traditional form of kerbstone.

In FIG. 25, a kerbstone 110, similar to that shown in FIG. 7, comprises a pair of lighting units 302 arranged in the forward wall 148 thereof. A power supply unit 304 is received in the body of the kerbstone 110.

Each lighting unit 302 comprises a hollow cylindrical body 306 (see FIGS. 27 & 28) which has a closed base 308 and an open screw threaded end 310.

The open screw threaded end is closed off by means of an end cap 312 which screw threadingly engages with the screw threaded open end 310. An elastomeric O-ring 314 is compressed between the open end 310 and the end cap 312 to seal the interior of the body 306.

The closed base 308 has a bore 316 formed therethrough which allows passage of an electrical cable 318. The bore is sealed by means of a bush 320.

The end cap 312 comprises a circular face plate 322 having a larger diameter than the cylindrical body 306. Four fastener bores 324 are formed through the face plate at regular positions around the periphery thereof. The face plate carries a transparent circular window 326 concentrically thereof which has a diameter slightly less than the diameter of the body 306.

A circular PCB 328 is connected to the cable 318 inside the hollow body 306. The PCB 328 carries an array of light emitting diodes (LEDs) 330. The LEDs 330 may be white, coloured or variable colour LEDs or a mixture thereof. For example, the outer ring 330a of LEDs may be colour variable between red, yellow and red, whilst the inner ring 330b of LEDs may be blue.

The power supply unit 304 comprises a battery 332 secured inside the body of the kerbstone 110 and a photovoltaic cell 334 arranged on the upper face of the kerbstone 110. The photovoltaic (or “solar”) cell 334 is connected electrically to the battery 332 and is arranged to provide power to the lighting unit 302 and to charge the battery 332 when illuminated by a sufficiently powerful light source, e.g. the sun.

FIG. 26 shows an assembly of three such kerbstones 110. In the assembly shown in FIG. 26, the lighting units 302 of all three kerbstones are powered by a single power unit 304 located on one of the three kerbstones 110. Electrical power is relayed along the assembly by appropriate cabling 336.

In FIG. 29, a kerbstone 110 similar to that shown in FIG. 25, further includes a parking sensor array 338. The parking sensor array 338 comprises a group of spaced ultrasound transceivers 340 which emit ultrasound waves and sense reflected ultrasound waves. Each transceiver 340 is powered by the power supply unit 304 and controlled by a controller 342 (the electrical connections are omitted for clarity but would be within the ambit of a skilled person to select accordingly). The controller 342 includes a remote communication system, such as a radio or GSM based system to enable data to be sent to and from the controller to and from a remote location.

The kerbstone 110 of FIG. 29 allows automation of parking and traffic control. For example, in a high security area where no stopping is permitted, the kerbstone could sense the presence of a vehicle near the kerb and the controller 342 could send a signal to a remote central control location after a predetermined amount of time to alert the control centre to the presence of the vehicle. That message, in turn, could automatically train security cameras on the kerbstone in question and, if necessary, direct security forces, such as police, to the alert location.

Alternatively, the controller could send a message via SMS to a traffic warden where the kerb location has restricted parking, for example double yellow lines. The SMS or other data message may include GPS data to assist the warden in locating the relevant kerb. Still further, the kerbstone 110 could be used in conjunction with a metered parking scheme whereby the kerbstone could sense whether a vehicle parked near the kerb had exceeded its permitted or paid for parking time and a similar messaging system could be used.

The use of variable colour LEDs could also supplement that system. For example, green coloured LEDs could indicate a paid up parking slot, yellow could indicate the paid up time was about to expire and red could indicate overtime. Likewise, the variable LEDs could indicate variable parking status. For example in an airport concourse green LEDs could indicate parking, yellow loading only, red no stopping and blue emergency vehicles only. By providing the controller with remote communication means, the colour of the LEDs could be selected according to traffic need.

Just as multiple kerbstones can be powered by a single power supply unit on one kerb, multiple kerbstones can be controlled by a single master controller 342 on one kerb with appropriate communication between kerbs, either wired or wirelessly.

FIG. 31 shows a kerbstone 110 similar to that of FIG. 7 with a reflective chevron strip 344 either in-moulded or affixed to the forward wall thereof.

FIG. 32 shows a kerbstone 110 similar to that of FIG. 7 with a drainage channel 346 affixed to the base 126 thereof. The channel 346 may be welded or glued to the base and is in fluid communication with the voids between the inner ribs 154. A drainage aperture 348 is formed in the front and forward walls 128, 148 of the kerbstone 110 between each pair of inner ribs 154.

In that way, when the kerbstone 110 of FIG. 32 is arranged in the ground alongside a road, water W running off the road can pass through the aperture 348 and into the channel 346. By arranging a row of such kerbstones 110 alongside a roadway, water runoff can be carried to the storm drain without the need for roadside gulleys.

In FIG. 33, a kerbstone 110 similar to that of FIG. 7 is shown. The kerbstone 110 of FIG. 33 has a series of inner ribs 154 arranged, regularly spaced along the length thereof. Supplementary upper ribs 350 are interposed between the inner ribs. The supplementary upper ribs 350 extend between the upper part of the rear wall 124 and the forward wall 148 to provide additional strength to the impact area of the kerbstone.

FIG. 34 illustrates a series of alternate inner rib profiles 154. From left to right in FIG. 34, inner rib profile 154a is a large honeycomb or hexagonal profile. Inner rib profile 154b is a smaller honeycomb profile between two inner ribs 154. Inner rib profile 154c is a series of closely spaced inner ribs with diagonal cross ribs. Inner rib profiles 154d and f are inner ribs 154 connected by single oppositely handed diagonal ribs. Inner rib profile 154e comprises a pair of inner ribs 154 connected by diagonal cross members.

FIG. 35 illustrates a kerbstone 110 similar to that of FIG. 7, in section, which has been treated by blowing with liquid molten plastic to form an outer plastic skin. This is advantageous as a non-uniformly coloured inner plastic structure can be treated cosmetically with a uniformly coloured outer coat. This allows the most structurally robust material to be selected without being constrained by aesthetic considerations.

It is further conceivable within the scope of the invention that any one or more of the features above described in a single embodiment of kerbstone may be combined with one or more other such features, including, without limitation:
front flange
rear flange
holes in the front and/or rear flanges
one or more front apertures
one or more rear apertures
top wall and/or forward wall of increased wall thickness
top wall and/or forward wall having an insert
end faces having retention elements
plugs in the base defined by the ribs or walls

1. A kerbstone having a body defined by a leading surface, a front face, a rear face, a base and first and second end faces, the leading surface comprising a top face and a forward face, the body being formed from a synthetic or elastomeric material and defining first and second retention formations on the first and second end faces, respectively, wherein the first and second retention formations extend from proximate the base to a position short of the top face.

2. The kerbstone according to claim 1 wherein the leading surface defines a first portion which is exposed in use, and the front face, rear face, base, and, first and second end faces, define a second portion which is buried in use and a further retention formation is provided on the second, buried portion.

3. The kerbstone according to claim 1 wherein the first retention formation comprises a projection from the first end face and the second retention formation comprises a recess, recessed into the second end face.

4. The kerbstone according to claim 2 wherein the further retention formation includes a flange arrangement.

5. The kerbstone according to claim 4 wherein the flange arrangement comprises a flange on the front face.

6. The kerbstone according to claim 4 wherein the flange arrangement comprises a flange on the rear face.

7. The kerbstone according to claim 1 wherein the body defines a hollow cavity.

8. The kerbstone according to claim 7 wherein the body is open at the base.

9. The kerbstone according to claim 7 wherein the body defines one or more ribs, the one or more ribs dividing the cavity into at least two compartments.

10. The kerbstone according to claim 9 wherein each of the one or more ribs is scalloped proximate the base.

11. The kerbstone according to any preceding claim wherein the synthetic or elastomeric material is low density polyethylene.

12. The kerbstone according to claim 2 wherein the first portion is formed from a different synthetic or elastomeric material to the second portion.

13. The kerbstone according to claim 2 wherein the material forming the first portion is 25 to 50% stronger than the material forming the second portion.

14. The kerbstone according to claim 1 wherein the kerbstone has a front wall, a rear wall, a top wall, a forward wall and first and second end walls and the top wall and forward wall have a wall thickness 50% to 150% greater than that of the rear wall, most preferably 100% greater.

15. The kerbstone according to claim 1 wherein at least one of the rear face and front face has at least one hole for receiving, in use, a concrete mix.

16. The kerbstone according to claim 1 wherein the leading surface has a non-slip finish.

17. A kerbstone according to claim 1, in which a photovoltaic cell or a battery is received in the body.

18. A kerbstone according to claim 1, in which a light source is received in the body.

19. A kerbstone according to claim 18, in which the light source comprises one or more light emitting diodes, most preferably colour variable light emitting diodes.

20. A kerbstone according to claim 1, in which a sensor is received in the body.

21. A kerbstone according to claim 20, in which the sensor is one of a vehicle parking sensor, a vehicle speed sensor, a light sensor or other vehicular approach sensor.

22. A kerbstone according to claim 1, in which the kerbstone includes communication means to allow the kerb to communicate with a remote location.

23. A kerbstone according to claim 22, in which the communication means comprises a mobile telephone or other wireless communication means.

24. A kerbstone according to claim 1, in which the kerbstone comprises a sensor and a light source whereby activation of the sensor causes the light source to be illuminated or, where a variable colour LED is provided, causes the variable colour LED to be illuminated or to change colour.

25. A kerbstone according to claim 24, in which the sensor is a vehicle approach sensor and the light source is illuminated intermittently to provide a warning signal.

26. A kerbstone according to claim 22, in which the kerbstone includes a light source, preferably comprising one or more light emitting diodes, most preferably colour variable light emitting diodes, whereby the light source may be activated remotely via the communication means.

27. A kerbstone according to claim 22, in which the kerbstone includes a sensor whereby data from the sensor can be passed from the kerbstone to a remote location via the communication means.

28. A kerbstone according to claim 27, in which the kerbstone includes a light source, preferably comprising one or more light emitting diodes, most preferably colour variable light emitting diodes, whereby the light source may be activated remotely via the communication means.

29. A kerbstone according to claim 1 in which the kerb has a light reflective surface over at least part of the front or top faces thereof.

30. A kerbstone according to claim 1 having a drainage channel formed integrally therewith or attached thereto.

31. A kerbstone according to claim 30, in which the front face of the kerbstone has one or more apertures formed therein and in fluid communication with the drainage channel.

32. A kerbstone according to claim 9, in which the ribs have a higher density in the upper part of the kerbstone.

33. A kerbstone assembly comprising two kerbstones according to claim 1 wherein the first retention formation defines an external, upward-facing abutment surface and the second retention formation defines an internal, downward-facing abutment surface, the abutment surfaces engaging, in use, so that the second kerbstone is at least partially supported by the first kerbstone.

34. A kerbstone assembly comprising at least two kerbstones according to claim 18, 20 or 22 in which power for the light source, sensor or communication means on one of the kerbstones is provided by a power supply on another of the kerbstones.

35-113. (canceled)
